(19) United States
(12) Patent Application Publication
(10) Pub. No.: US 2019/0072266 A1
(43) Pub. Date: Mar. 7, 2019

(54) LED Luminaire Having Improved Thermal Management

(71) Applicant: George P Pollack, Oak Brook, IL (US)

(72) Inventor: George P Pollack, Oak Brook, IL (US)

(21) Appl. No.: 16/148,440

(22) Filed: Oct. 1, 2018

Related U.S. Application Data
(63) Continuation-in-part of application No. 15/158,688, filed on May 19, 2016, now abandoned.

(51) Int. Cl. F21V 29/85; H05B 33/08; F21V 29/76; F21V 31/00

(52) U.S. Cl. CPC F21V 29/85; F21V 31/00; F21V 29/76; H05B 33/08

(57) ABSTRACT

A vapor proof LED luminaire having improved thermal management is provided. The luminaire includes a vapor proof interior having a heat sink with a central aperture within the vapor proof interior and wherein the heat sink is surrounded by a series of annular fins separated by annular slots. The luminaire includes an internal space of a hollow metallic cylinder connected to the central aperture at one end and having an LED proximate the other end of the hollow metallic cylinder. The internal space of the hollow metallic cylinder provides a conduit to the central aperture for air heated by the LED; and wherein the vapor proof LED luminaire does not comprise a heat pipe.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc, applications of the Related Application(s) to the extent such subject matter is not inconsistent herewith:

U.S. patent application Ser. No. 15/158,688 entitled “Air Cooled LED Luminaire”, naming George P. Pollack as inventor, filed May 19, 2016.

### FIELD

This invention pertains to high efficiency, high lumen output luminaires, in general and LED luminaire thermal management in particular.

### BACKGROUND

LED light sources do not tend to fail catastrophically. Instead, the light output degrades gradually over time. The useful operating lifetime of a power LED is extremely long and may be longer than the lifetime of the product or thermal management devices used to control and minimize the generated heat. Much of the electricity in an LED device becomes heat rather than light. If the generated heat is not removed, the LEDs run at high temperatures, which not only lowers the LED efficiency, but also makes the LED less reliable. Thus, thermal management of high-power LEDs is a crucial.

Many LED devices use heat pipes in conjunction with radiator fins to dissipate heat generated by the LED lamp. Heat pipes transfer heat more efficiently and evenly than solid conductors such as aluminum or copper because of their lower total thermal resistance. The heat pipe is filled with a small quantity of working fluid (water, acetone, nitrogen, methanol, ammonia or sodium). Heat is absorbed by vaporizing the working fluid. The vapor transports heat to the condenser region where the condensed vapor releases heat to a cooling medium. The condensed working fluid is returned to the evaporator by gravity, or by the heat pipe's wick structure, creating capillary action. Both cylindrical and planar heat pipe variants have an inner surface lined with a capillary wicking material.

While heat pipes are generally reliable they can, and do, fail for a variety of reasons such as the working fluid escaping the heat pipe due to leaks caused by thermal shock, manufacturing defects, persistent high temperatures, physical shock or environmental operating conditions. Once the heat pipe fails the working life of the LED device will be significantly shortened necessitating the need for replacing the LED device well ahead of schedule.

Thus, there is a need in the art for high lumen output luminaires having enhanced efficiency. There is also a need in the art for such luminaires that are safe and easy to employ in moist and wet conditions and that can withstand demanding applications where exposure to caustic and corrosive environments will quickly degrade prior art cast aluminum fixtures. Finally, there is also a need in the art for luminaires that do not use heat tubes and efficiently dissipate LED generated heat to maximize the lifetime of the LED luminaire.

### SUMMARY

Embodiments of the present luminaire achieve previously unknown luminaire efficiency in terms of lumens delivered per watt of current drawn. Embodiments of the present luminaire achieve previously unknown luminaire efficiency by, inter alia, elevating a LED chip to adjacent the exposed end of an elongated metallic cylinder affixed to a unique machined heat dissipation sink where the LED chip is adjacent to the exposed end of the luminaire globe. This structure increases lumen output, produces broad lighting coverage and provides efficient thermal management of the heat generated by the LED without heat pipes. Also, the strategic use of thermoplastic components electrically isolates the machined heat dissipation sink thus preventing or minimizing corrosion due to electrochemical action. In other words, electrically isolating the heat dissipation sink prevents the heat sink from becoming a galvanic or sacrificial anode, particularly in, or near, salt water environments. The luminaires are made vapor proof by a unique combination of gaskets. As a result, embodiments of the present luminaire can be used, for example, in particularly sensitive applications such as offshore oil rigs, chemical plants, and agricultural installations.

In accordance with one embodiment of the invention a vapor proof LED luminaire having improved thermal management is provided. The luminaire includes a vapor proof interior having a heat sink with a central aperture surrounded by a series of annular fins separated by annular slots. The vapor proof LED luminaire includes a hollow metallic cylinder connected to the central aperture at one end and having an LED proximate the other end of the hollow metallic cylinder. The hollow metallic cylinder and the internal space of the hollow metallic cylinder provides a thermal conduit to the central aperture for air heated by the LED. The vapor proof LED luminaire does not comprise a heat pipe.

The invention is also directed towards a LED luminaire having improved thermal management. The LED luminaire includes a heat sink having a central aperture surrounded by a plurality of annular radiating fins separated by annular slots. The LED luminaire also includes a hollow heat transfer cylinder connected to the central aperture at one end and having an LED proximate the other end of the hollow heat transfer cylinder. The hollow heat transfer cylinder provides a thermal conduit to the central aperture for air heated by the LED. The hollow heat transfer cylinder also dissipates heat generated by the LED from the inner surface area through the first cylinder wall thickness to the outer surface area. The LED luminaire does not comprise a heat pipe.

### BRIEF DESCRIPTION OF THE DRAWINGS

In order to aid in understanding the invention, it will be described in connection with exemplary embodiments with reference to the accompanying drawings in which like numbers will be given to like features wherein:

FIG. 1 is a perspective view of a luminaire embodiment in a typical inverted installation;

FIG. 2 is a view of a luminaire corresponding to that of FIG. 1 in which its guard and glass globe have been removed;

FIG. 2A is a view of a partial luminaire embodiment in which the length of the luminaire metal cylinder integral to thermal management of the LED luminaire is substantially reduced;

FIG. 3 is a cross-sectional view of the embodiment of FIG. 1 taken along lines 3-3 of FIG. 1; and

FIG. 4 is an exploded view of the luminaire embodiment of FIG. 1.

### DETAILED DESCRIPTION OF THE INVENTION

Turning to the Figures, a luminaire 10 is shown having a base 12, a heat sink 14, a generally hollow cylinder 16, a coupling member 18, a globe 20 and a guard 24. Base 12, which serves as a sealed compartment for the LED drive (54), is optionally mounted on a junction box 26 by a series of machine screws 27 as will be described in more detail below. Base 12 includes an aperture 13 in its surface 15 through which LED leads pass, as described below. In one embodiment, luminaire 10 can deliver over 95.4 lumens per watt using a 20 W LED light source.

Preferably, base 12, coupling member 18, guard 24, a junction box 26 will be made of a plastic capable of withstanding the heat produced by the luminaire. A glass reinforced thermoplastic that resists impact, high temperature and corrosion (such as Lexan plastic) is a preferred plastic material for these components. The use of thermoplastics for these components reduces the weight of the luminaire. Also, but for the exposed outer surface of the heat sink, the entire luminaire is encased in thermoplastic and therefore insulated from the heat produced within the luminaire, minimizing risk to people in the vicinity of the luminaire.

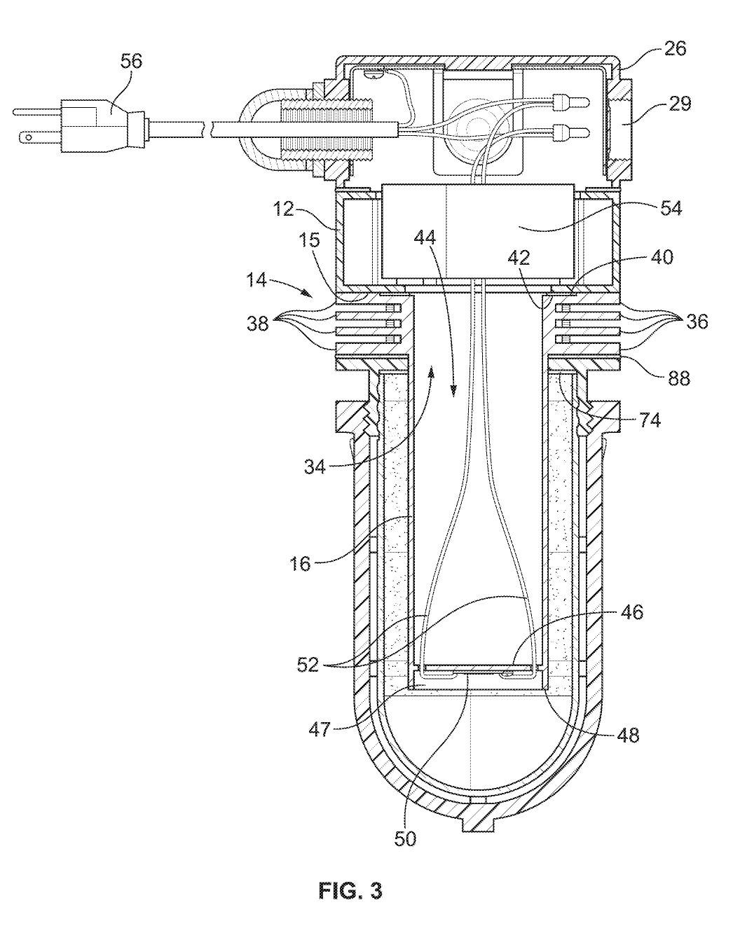

As can best be seen in FIG. 3, heat stack 14, which preferably is made of machined aluminum, has a central aperture 34 as well as a series of annular tins 36 separated by annular slots 38 which encircle the central aperture. Preferably the heat sink 14 is formed from extruded aluminum and clear anodized to minimize porosity. Also, the heat sink preferably is turned from a single piece of aluminum bar stock to maximize its heat dissipation characteristics. It will be appreciated that any suitable heat sink material may be used, such as, for example, ceramic heat sinks. Although other heat sink designs having fins, vanes or other protruding features to dissipate heat can be used, the illustrated design is preferred and has been found to be particularly effective.

A gasket 40 preferably made of silicone encircles aperture 34 and is positioned between surface 42 of the heat sink and surface 15 of base 12. Surface 42 of the heat sink may be undercut as shown to accommodate a portion of the thickness of the gasket. This gasket helps ensure vapor proofing of the luminaire and also limits heat transfer between the heat sink and the junction box. It will be appreciated that the vapor proof enclosure requires novel heat dissipation management to dissipate heat generated by the LED 46.

Cylinder 16, which is a key component of embodiments of the invention, is a metal tube and preferably is an extruded aluminum tube that is dimensioned to fit to central aperture 34 of the heat sink. Preferably the cylinder is formed from extruded aluminum and clear anodized to minimize porosity and enhance durability. It will be appreciated that any suitable heat transfer material may be used for cylinder 16, such as, for example, heat transferring ceramics. In the illustrated embodiment, cylinder 16 has an inside diameter of about 1.75 inches and an outside diameter of about 2.25 inches. It will be appreciated that the walls of cylinder 16 are approximately one-half inch thick in the illustrated embodiment and the heat dissipated by cylinder 16 is a function of the internal surface area of cylinder 16 conducting heat generated by the led through the cylinder 16 walls to the external surface are of cylinder 16. It will be appreciated that the thickness of cylinder 16 walls controls the rate of heat transfer from the inner surface of cylinder 16 to the outer surface of cylinder 16. It will be further appreciated that the walls of the cylinder 16 may be any suitable thickness for thermal management.

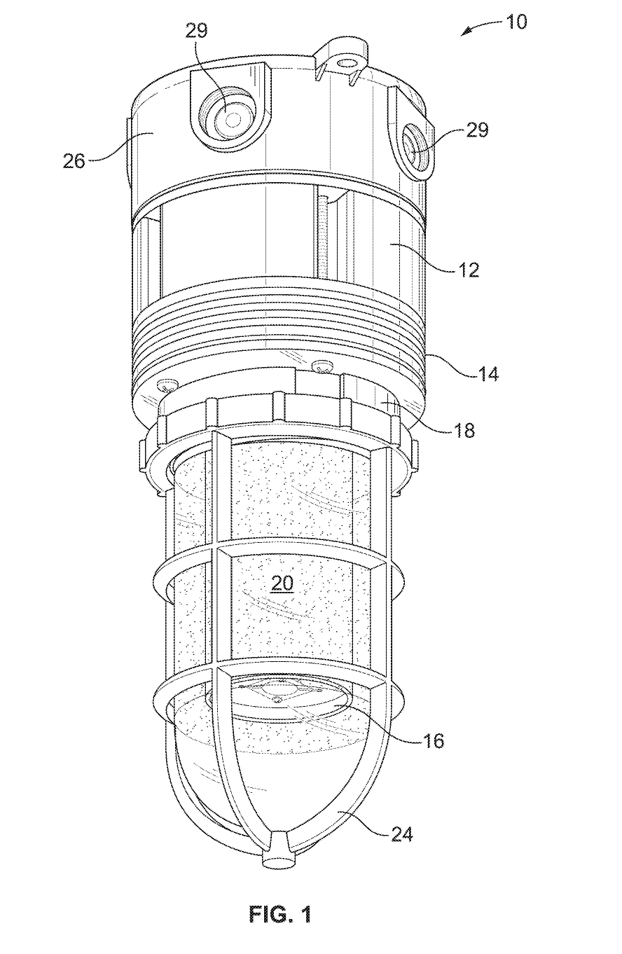

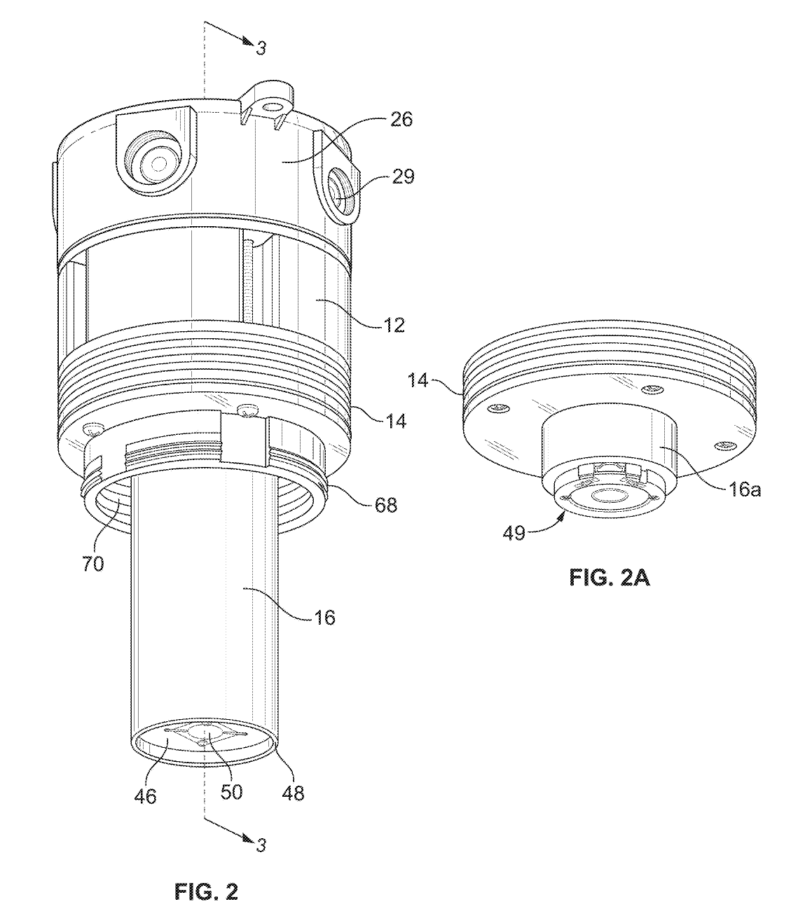

In conjunction with the walls of cylinder 16 the interior hollow length of cylinder 16 may vary depending on thermal management requirements. In one alternative embodiment shown in FIG. 2A, cylinder 16 may be reduced in length from that illustrated in FIGS. 1, 2, 3 and 4 to that of cylinder 16a. In this embodiment, globe 20 may be entirely frosted to create a generally uniform glow along the entirety of the globe generally simulating an incandescent light source.

Cylinder 16 (and cylinder 16a) are preferably turned from a single piece of stock with heat sink 14. However, these cylinders may be welded to heat sink 14 and, least preferably, press fit to the heat sink. The unitary structure or attachment by weldment ensures efficient heat transfer between the cylinder and the heat sink to maximize dissipation of heat from LED 50 (discussed immediately below) through the wall of the cylinder and along its hollow interior 44 to the heat sink where the heat is radiated into the environment.

The interior of the cylinder 16 is hollow to facilitate the movement of heat through the cylinder to the heat sink 14. The combination of heat dissipating cylinder 16 and heat sink 14 achieves heat dissipation not heretofore seen in LED luminaires or similar lighting fixtures without heat pipes. Cylinder 16 also physically elevates LED 50 into the clear, hemispherical portion of globe 20 (as discussed below) thereby enhancing the luminaire light output.

In the illustrated embodiment, a platform 46 is mounted above the edge 48 of cylinder 16 forming a recess 47 at the end of the cylinder and circling LED 50. In alternate embodiments the recess will be eliminated to position the LED at the very end of cylinder 16, thereby achieving maximum light output and maximum heat dissipation. Platform 46 preferably is a turned disk of aluminum welded along its outside diameter at or near the exposed end of cylinder 16.

LED 50, which is preferably in the form of a square chip LED, may be attached directly to the surface of the platform as in FIG. 2. In alternative embodiments, for example, that illustrated in the embodiment of FIG. 2A, showing a shortened cylinder 16a, a chip socket such as a ZHAGA Consortium compliant chip socket 49 may be mounted on the platform and used to removably attach the LED. A thermal transferring grease is applied to the back of the LED and the face of the heat sink (16 and 16a).

Preferably the LED will comprise multiple LED chips packaged together as one lighting module which gives the appearance of a small lighting panel. This assembly is sometimes referred to as a “chips on board” or a “COB” assembly. LED 50 is connected by leads 52 which pass through holes in platform 46 (not shown) and run to a LED driver 54 located in base 12. The driver is wired to a conventional electrical plug 56 which can be used to connect the luminaire to a standard 110V AC electrical outlet. Other wiring arrangements may, of course, be used including wiring passing through conduit (not shown) affixed to threaded ports 29 in the junction box.

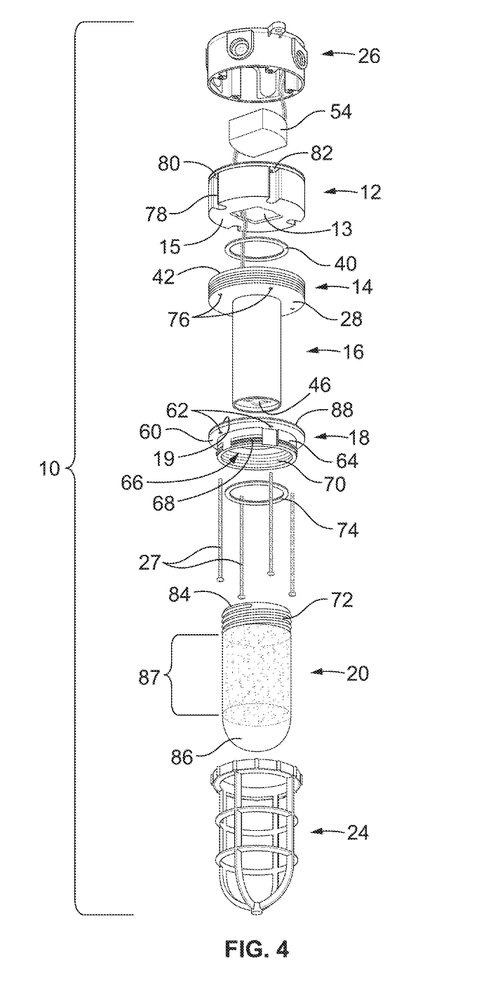

As can best be seen in FIG. 4, coupling member 18 includes an outer annular flat lip 60 having a series of holes 62 for receiving machine screws 27, an inwardly spaced annular wall 64 and an inner annular flat lip 66. Threading 70 is formed along the inner surface of the annular wall.

Globe 20 preferably is made of glass and has threading 72 corresponding to threading 70 along the inner surface of annular wall 64. Globe 20 also has a semi-spherical end 21 as shown. It may be clear or frosted. A globe preferably having a clear hemispherical end 86 and a frosted cylindrical portion 87 is presently preferred in the illustrated embodiment with an elongated cylinder 16. The hemispherical end may be frosted as well if desired. When the luminaire is assembled, globe 20 is screwed into the coupling member preferably with a second gasket 74 which is preferably made of silicone at the interface of the annular edge 84 of the globe and annular flat lip 66 of the coupling member. Additionally, preferably there will also be a third gasket 88 at the interface of surface 28 of the heat sink and surface 19 of the coupling member. Gaskets 40, 74 and 88 establish an air and watertight seal of the interior of the luminaire. The second gasket ensures an airtight seal between the globe and inner annular flat lip 66 to help ensure vapor proofing of the luminaire. As an alternate, polycarbonate globes can be substituted for glass globe 20 and will eliminate the need for guard 24. It will be appreciated that since the aluminum of the heat sink 14 and cylinder 16 are electrically isolated from any metallic mounting surfaces, corrosion of the heat sink 14 and cylinder 16 due to galvanic action is minimized. It will be further appreciated that heat sink 14 and cylinder 16 are machined aluminum and not die cast, thus reducing the inherent porosity of heat sink 14 and cylinder 16 and again minimizing corrosion.

Assembly of the luminaire can best be understood with reference to FIG. 4. This exploded view shows the luminaire in an inverted position corresponding to a typical installation of the fully assembled unit. However, assembly of the unit may be done with junction box 26 at the top in this illustration orientation, base 12 positioned below of the junction box, heat sink 14 opposite surface 15 of the base, and coupling member 18 resting on surface 28 of the heat sink. In order to assemble these components together, machine screws 27 are passed through holes 62, holes 76 in the heat sink, past slots 78 in the base, through holes 80 in the base and screwed home in threaded holes 82 of the junction box. As noted above, LED 50 is pre-mounted to platform 46. Once this initial assembly is completed, threads 72 of globe 20 are screwed home into coupling member 18 to engage threads 68 of the inner annular wall of the coupling member and form a seal with the coupling member and edge 84 of the globe by way of gasket 74. Then, guard 24 is screwed onto threads 68 of the coupling member to complete the assembly of the luminaire. A set screw in the base of guard 24 may be used to secure the assembly and prevent tool-less access to the LED. When the alternate polycarbonate globe is used, it may be secured in place with a set screw in the base of coupling member 18 to prevent tool-less access to the LED.

The use of the terms “a” and “an” and “the” and similar referents in the context of describing the embodiments of the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments are described herein, including the best mode currently known to the inventors for carrying out the invention. It should be understood that the illustrated embodiments are exemplary only, and should not be taken as limiting the scope of the invention.

Table of Reference Characters

| Reference No. | Description |
|---|---|
| 10 | luminaire |
| 12 | base |
| 13 | aperture in base |
| 14 | heat sink |
| 15 | surface of base |
| 16 | hollow cylinder |
| 16a | reduced length cylinder |
| 17 | hollow interior of cylinder |
| 18 | coupling member |
| 19 | surface of coupling member |
| 20 | globe |
| 24 | guard |
| 26 | junction box |
| 27 | machine screws |
| 28 | surface of heat sink |
| 29 | threaded ports in junction box |
| 34 | central aperture in heat sink |
| 36 | annular fins |
| 38 | heat sink slots |
| 40 | gasket |
| 42 | surface of heat sink |
| 44 | hollow interior of cylinder |
| 46 | LED platform |
| 47 | recess at exposed end of cylinder |
| 48 | cylinder edge |
| 49 | ZHAGA Consortium compliant chip socket |
| 50 | LED |
| 52 | LED leads |
| 54 | LED driver |
| 56 | electrical plug |
| 60 | coupling member annular flat lip |
| 62 | holes in flat lip for receiving machine screws |
| 64 | coupling member inwardly spaced annular wall |
| 66 | coupling member inner annular flat lip |
| 68 | threads on annular wall |
| 70 | threading on inner annular wall |
| 72 | threads on globe |
| 74 | second gasket |
| 76 | holes in heat sink |
| 78 | clearance slots in base |
| 80 | holes in base |
| 82 | threaded holes in junction box |
| 84 | edge of globe |
| 86 | hemispherical end of globe |
| 87 | cylindrical portion of globe |
| 88 | third gasket |

What is claimed is:

1. A vapor proof LED luminaire having improved thermal management, the luminaire comprising:
a vapor proof interior;
the vapor proof interior comprising:
a heat sink having a central aperture within the vapor proof interior and wherein the heat sink is surrounded by a series of annular fins separated by annular slots;
an internal space of a hollow metallic cylinder connected to the central aperture at one end and having an LED proximate the other end of the hollow metallic cylinder; wherein the internal space of the hollow metallic cylinder provides a conduit to the central aperture for air heated by the LED; and
wherein the vapor proof LED luminaire does not comprise a heat pipe.

2. The vapor proof LED luminaire as in claim 1 wherein the hollow metallic cylinder comprises an inner surface area, an outer surface area, a first inner diameter and a first outer diameter, wherein the first inner diameter and the first outer diameter define a first cylinder wall thickness and wherein the hollow metallic cylinder dissipates heat generated by the LED from the inner surface area through the first cylinder wall thickness to the outer surface area.

3. The vapor proof LED luminaire as in claim 2 wherein the hollow metallic cylinder comprises a hollow machined aluminum metallic cylinder.

4. The vapor proof LED luminaire as in claim 3 wherein the first inner diameter comprises 1.75 inches.

5. The vapor proof LED luminaire as in claim 3 wherein the first outer diameter comprises 2.25 inches.

6. The vapor proof LED luminaire as in claim 1 comprising a globe comprising a cylindrical portion and a hemispherical portion and where the cylindrical portion encloses the hollow metallic cylinder and the LED.

7. The vapor proof LED luminaire as in claim 6 further comprising a mounting platform disposed at the other end of the hollow metallic cylinder for mounting the LED and elevating LED into the hemispherical portion.

8. The vapor proof LED luminaire as in claim 6 further comprising a coupling member for coupling the cylindrical portion to the heat sink.

9. A LED luminaire having improved thermal management, the luminaire comprising:
a heat sink having a central aperture and wherein the heat sink is surrounded by a plurality of annular radiating fins separated by annular slots;
a hollow heat transfer cylinder connected to the central aperture at one end and having an LED proximate the other end of the hollow heat transfer cylinder; wherein the internal space of the hollow heat transfer cylinder provides a conduit to the central aperture for air heated by the LED, wherein the hollow heat transfer cylinder comprises an inner surface area, an outer surface area, a first inner diameter and a first outer diameter, wherein the first inner diameter and the first outer diameter define a first cylinder wall thickness and wherein the hollow heat transfer cylinder dissipates heat generated by the LED from the inner surface area through the first cylinder wall thickness to the outer surface area; and
wherein the LED luminaire does not comprise a heat pipe.

10. The LED luminaire as in claim 10 wherein the hollow heat transfer cylinder comprises a hollow aluminum metallic cylinder.

11. The LED luminaire as in claim 10 wherein the hollow heat transfer cylinder comprises a hollow ceramic cylinder.

12. The LED luminaire as in claim 10 wherein the heat sink comprises an aluminum heat sink.

13. The LED luminaire as in claim 10 wherein the heat sink comprises a ceramic heat sink.

14. The LED luminaire as in claim 10 further comprising a globe comprising a cylindrical portion and a hemispherical portion and where the cylindrical portion encloses the hollow metallic cylinder and the LED.

15. The LED luminaire as in claim 14 wherein the globe comprises a polycarbonate globe.

16. A passive thermally managed LED luminaire, the luminaire comprising:
a heat sink;
a heat transfer cylinder connected to the heat sink at one end and having an LED proximate the other end of the heat transfer cylinder; and
wherein the vapor proof LED luminaire does not comprise a heat pipe.

17. The passive thermally managed LED luminaire as in claim 16, wherein the heat transfer cylinder comprises;
a hollow cylinder having an internal space defined by an internal surface area defining internal walls, wherein the internal space passively thermally manages air heated by the LED, wherein passively thermally managing air heated by the LED comprises:
dissipating heat from the heated air in contact with the internal surface through the hollow cylinder walls; and
providing a conduit for the heated air from the LED to the heat sink.

18. The passive thermally managed LED luminaire as in claim 16 wherein the heat sink comprises an aluminum heat sink.

19. The passive thermally managed LED luminaire as in claim 16 wherein the heat sink comprises a machined aluminum heat sink.

20. The passive thermally managed LED luminaire as in claim 16 wherein the hollow cylinder comprises a hollow machined aluminum metallic cylinder.
